(19) United States
(12) Patent Application Publication
(10) Pub. No.: US 2011/0215554 A1
(43) Pub. Date: Sep. 8, 2011

(54) Gas Generating System

(76) Inventor: Brian A. Mayville, Troy, MI (US)

(21) Appl. No.: 12/716,824

(22) Filed: Mar. 3, 2010

(51) Int. Cl. B60R 21/16; B23K 11/02

(52) U.S. Cl. 280/728.2; 219/104

(57) ABSTRACT

A housing assembly for a gas generating system includes a housing and a shim welded to the housing to provide a substantially gas-tight seal between the shim and the housing. A method for attaching a shim to a housing is also described.

### CROSS REFERENCE TO RELATED APPLICATIONS

This application claims the benefit of provisional application Ser. No. 60/209,068, filed on Mar. 3, 2009.

### BACKGROUND OF THE INVENTION

The present invention relates to gas generating systems which generate gas for inflating inflatable devices.

### SUMMARY OF THE INVENTION

In one aspect of the embodiments of the present invention, a housing assembly for a gas generating system includes a housing and a shim welded to the housing to provide a substantially gas-tight seal between the shim and the housing.

In another aspect of the embodiments of the present invention, a method is provided for attaching a shim to a housing. The method includes the steps of securing the shim to the housing, and welding the shim to the housing so as to form a substantially gas-tight seal between the shim and the housing.

### BRIEF DESCRIPTION OF THE DRAWINGS

FIG. 1 is a cross-sectional side view of a gas generating system in accordance with one embodiment of the present invention.

FIG. 2 is a cross-sectional side view of an inner housing in accordance with one embodiment of the present invention.

FIG. 2A is a cross-sectional end view of the inner housing shown in FIG. 2.

FIG. 3 is a plan view of a shim suitable for attachment to an inner housing in accordance with one embodiment of the present invention.

FIGS. 4A-4C are various embodiments of the inner housing of FIGS. 2 and 2A with the shim of FIG. 3 attached thereto.

FIGS. 4D shows one example of a method for securing a shim to an inner housing in accordance with one embodiment of the present invention.

FIG. 5 is a schematic view of a vehicle occupant protection incorporating a gas generating system in accordance an embodiment of the present invention.

### DETAILED DESCRIPTION

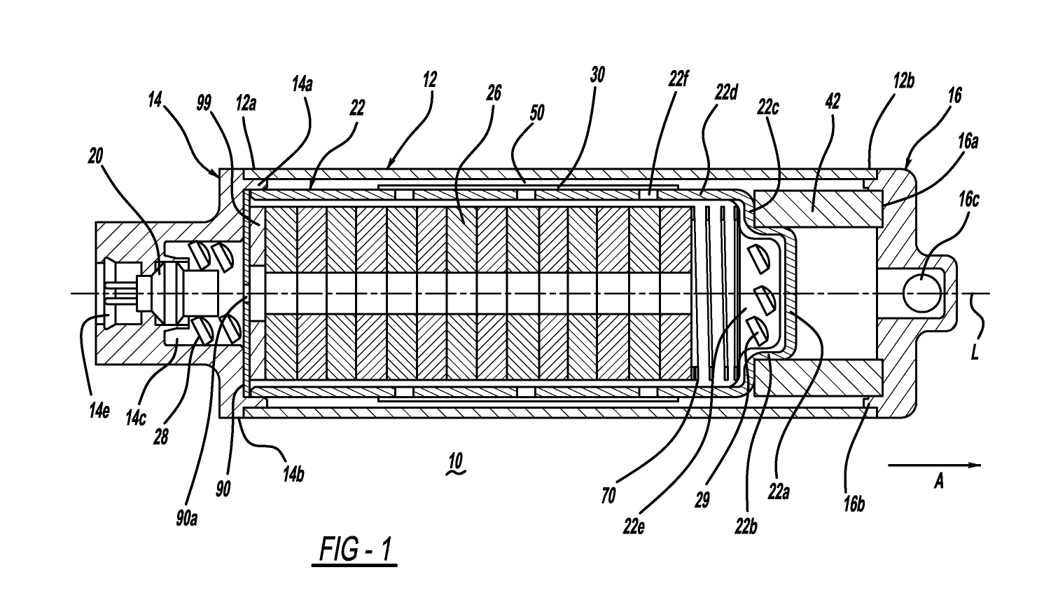

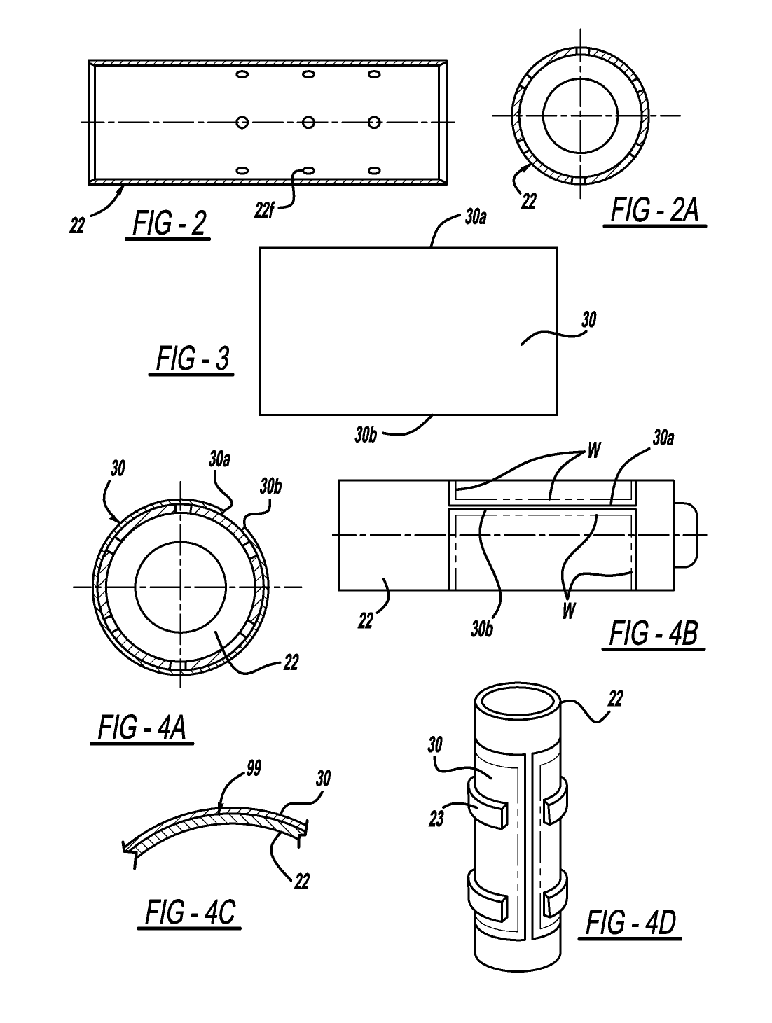

FIG. 1 shows a gas generating system 10 in accordance with one embodiment of the present invention.

Gas generating system 10 includes an elongate, generally cylindrical outer housing 12 having a first end 12a and a second end 12b. Outer housing 12 is made from a metal, metal alloy, or other suitable material and may be a cast, drawn, extruded, or otherwise suitably formed.

In the embodiment shown in FIG. 1, a first end closure 14 is secured at housing end 12a using one or more known methods, to close and seal the end of the outer housing. First end closure 14 includes a wall 14a formed proximate and spaced apart from a periphery of the end closure. Wall 14a extends into a flow passage 50 formed between outer housing 12 and an inner housing 22 (described below) when the end closure 14 is assembled to the outer housing. Wall 14a may form an interference fit with both outer housing 12 and inner housing 22 to provide a substantially gas-tight seal between the outer and inner housings. A shoulder 14b radially exterior of wall 14a abuts the outer housing. End closure 14 also has a central orifice 14e extending therethrough into a cavity 14c in which a quantity of a known or suitable booster material 28 (described below) is positioned. In a manner known in the art, combustion of booster material 28 generates combustion products which produce combustion of gas generant 26 (described below) positioned in inner housing 22. First end closure 14 is made from a metal, metal alloy, or other suitable material and may be a stamped, cast, molded, or otherwise suitably formed.

Referring again to FIG. 1, first end closure 14 supports an igniter 20 positioned so as to enable fluid communication with cavity 14c upon activation of the igniter. In a manner known in the art, activation of the igniter produces combustion of the booster material 28. igniter 20 may be formed as known in the art. One exemplary igniter construction is described in U.S. Pat. No. 6,009,809. herein incorporated by reference. Other igniters mountable so as to be in communication with end closure cavity 14c may also be used.

In the embodiment shown in FIG. 1, a quantity of a known auto-ignition material (not shown) may positioned in fluid communication with booster material 28 to prompt ignition of the booster material upon external heating of the gas generating system, in a manner well-known in the art.

A second end closure 16 is secured at housing end 12b using one or more known methods, to close and seal housing end 12b. Second end closure 16 includes a groove 16a formed therealong for receiving a portion of a filter 42 therein, and a wall 16b bordering groove 16a. Wall 16b extends into flow passage 50 between outer housing 12 and filter 42 when the end closure 16 is assembled to the outer housing. Second end closure 16 also has one or more gas exit openings 16c formed therein to enable fluid communication between the interior of housing 12 and an exterior of the housing.

Inner housing 22 is inwardly radially spaced from outer housing 12 and is substantially coaxially oriented along a longitudinal axis L of the outer housing. Inner housing 22 has an elongate, substantially cylindrical body including a base portion 22a, a first wall 22b extending from the base portion, a shoulder 22c extending from first wall 22b, and a second wall 22d extending from shoulder 22c. Base portion 22a and first wall 22b define a cavity 22e for storing therein a known or suitable ignition or booster material 29 in fluid communication with gas generant material 26 (described below). Booster material 29 may have the same composition as booster material 28 in cavity 14c, or material 29 may have a different composition than material 28. In a manner known in the art, combustion of booster material 29 generates combustion products which produce combustion of gas generant 26 positioned in inner housing 22. Inner housing also has a plurality of gas exit apertures 22f formed along a portion thereof. Annular gas flow passage 50 extends between outer housing 12 and inner housing 22. Gases and other combustion products escaping from inner housing 22 through apertures 22f flow along passage 50 in the direction indicated by arrow “A”, toward outer housing second end 12b. In an alternative embodiment inner housing 22 is open at both ends. Inner housing 22 may he made from carbon steel, stainless steel, or another suitable materia may be extruded, drawn, cast, molded, or otherwise suitably formed.

Referring now to FIGS. 3-4D, a rupturable, fluid-tight seal in the form of a burst shim 30 is positioned to seal inner housing 22, to facilitate an increase in pressure within the inner housing during combustion of the gas generant material and to aid in preventing moisture from entering the inner housing prior to ignition of the gas generant material.

FIG. 3 shows a detailed view of an exemplary fluid-tight seal or shim 30 suitable for use with the present invention. Shim 30 may be formed from a sheet of material made from any of various foils, films, or other suitable materials depending on the desired performance characteristics of gas generating system 10. For example, seals made from materials and/or having structures which are relatively more or less readily ruptured may be used. In one particular embodiment, shim 30 is formed from stainless steel.

In the embodiments shown herein, shim 30 is attached to inner housing 22 using a welding process. The welding process attaches the shim to the inner housing so as to form a substantially gas-tight seal between the shim and the inner housing. This acts to prevent fluid communication between an interior of the housing and the portion of the shim exterior of the weld, effectively sealing the inner housing so as to facilitate an increase in pressure therein during gas generant combustion. This promotes more efficient combustion of the gas generant material. In certain particular embodiments, the shim is attached to the inner housing 22 using a laser beam welding process. Any suitable type of laser may be used. For example, a known solid state laser (such as a Nd:YAG-type laser) or a CO2-type laser may be used, depending on the requirements of a particular application including such factors as the thicknesses of the parts being welded together, the type of weld joint desired, and the properties (such as reflectivity, melting point, and others characteristics) of the materials from which the welded parts are formed.

In the embodiments of the inner housing sub-assembly described herein, the shim 30 may he affixed to the inner housing 22 prior to welding to form a shim/inner housing pre-assembly. The shim/inner housing pre-assembly may then be mounted on suitable fixturing and/or on a positioning device (for example, an x-y table) so that the position of the pre-assembly can be varied during welding to expose the portions of the assembly to be welded to a static laser beam emitting apparatus. Alternatively, the pre-assembly may be fixed and the laser beam emitting apparatus may be movable along a path which is programmable or otherwise adjustable to weld the shim to the inner housing along a pre-defined path. Alternatively, the positions of both the laser beam emitting apparatus and the fixture holding the pre-assembly may be adjustable to achieve the desired weld path.

Any suitable method may be used for securing the shim to inner housing 22 for welding. In one embodiment (FIG. 4D), a suitable clip 23 or other retaining device is applied to affix the shim 30 to the inner housing 22 over openings 22f prior to welding. The shim may then be contour welded to the inner housing.

In another embodiment, shim 30 is secured to inner housing 22 by capping each open end of the inner housing to seal the housing, positioning the shim over the inner housing openings 22f, and then partially evacuating the interior of the inner housing using a pump or other means in fluid communication with the inner housing interior to extract a portion of the air therefrom. Atmospheric pressure maintains the shim in position on the inner housing outer surface during the welding process. It is understood that any cap or seal applied to an open end of the housing is configured to form a seal with the housing end that will help provide and maintain a pressure differential between the housing interior and the external atmosphere sufficient to maintain the shim in position on the housing during the welding process.

In yet another embodiment, a quantity of an adhesive material is applied to selected portions of the shim and/or the inner housing to secure the shin to the inner housing during the welding process.

In one embodiment, a first portion of shim 30 is secured to inner housing 22 by a suitable fixture while a second portion of the shim is welded to the inner housing. After the second portion of the shim has been secured to the inner housing, the inner housing is detached from the fixture and the first portion of the shim is then welded to the inner housing.

Referring to FIGS. 4A and 4B, in one particular embodiment, shim 30 is wrapped and secured around inner housing 22 as shown to cover inner housing openings 22f. A laser beam is then applied along an outer edge of the shim to weld the shim to the inner housing. The shim is thus contour welded to the inner housing, with the weld extending along lines “W” as shown in FIG. 4B.

Referring to FIG. 4C , in another particular embodiment, shim 30 is dimensioned such that it may be wrapped around the shim as shown so that opposing edges 30a and 30b of the shim are adjacent each other (i.e., lying either in contact with each other or close proximity to each other) so that a butt welded joint 99 may be formed along the opposing edges by applying a suitably modulated laser beam to the junction of the edges 30a and 30b (or to the gap formed between the edges 30a and 30b). This reduces processing time by effectively welding two opposed edges of the shim to the inner housing in a single pass of the laser beam.

In another embodiment, simultaneous welding is used to attach the shim to the inner housing. In this method, as known in the art, special reflective laser beam-shaping elements are used to heat substantial portions of the weld path (or the entire weld path) simultaneously.

Other laser welding methods may also be used, depending on the requirements of a particular application. The factors that may affect the fixturing used to hold the shim/inner housing pre-assembly during welding include part geometry and thickness, the type of weld joint desired, the desired cycle time, the materials from which the parts to be welded are formed, and the desired shape of the weld path. The particular laser power settings and other processing parameters desirable for a particular welding method may be iteratively determined.

Other welding methods (for example, ultrasonic welding) may also be used.

Depending on the welding process used, the materials to be welded, and other factors, it may be necessary to deburr, clean, or otherwise prepare the parts to be welded prior to welding.

Referring again to FIG. 1, an orifice plate 90 is configured to channel (and optionally, to regulate) a flow of gases resulting from combustion of booster material 28. Plate 90 can be flat or bent or formed to any other desired configuration according to the needs of a particular application. One or more orifices 90a are formed in the orifice plate base portion, enabling fluid communication between end closure cavity 14c and gas generant material 26.

A quantity of a propellant or gas generant material 26 is positioned in inner housing 22. Any suitable gas generant material might be used and exemplary compounds are disclosed in, for example, U.S. Pat. Nos. 5,872,329, 6,074,502, and 6,210,505, 5,035,757, 5,872,329, 6,074,502, 6,287,400, 6,306,232 and 6,475,312 each incorporated herein by reference. The compositions described in these patents exemplify, but do not limit, gas generant compositions useful in the application described herein. In the embodiment shown in FIG. 1, the gas generant is in the form of stacked wafers. However, other forms of gas generant may be used, depending on the requirements of a particular application.

A cushion member 99 is positioned between orifice plate 90 and gas generant material 26 to aid in cushioning the gas generant material from shock and/or vibration. Cushion member 99 may be formed from a ceramic wool or other suitably compliant material.

Referring again to FIG. 1, a spring member 70 is positioned between inner housing shoulder 22c and gas generant material 26, to permit a degree of adjustability in the quantity of gas generant positioned in the inner housing, and to aid in cushioning the gas generant from shock and/or vibration. Spring member 70 may be a coil spring or any other suitable type of spring member.

In the embodiment shown in FIG. 1, an annular filter 42 is incorporated into the gas generating system for filtering particulates from gases generated by combustion of gas generant 26. In general, filter 42 is positioned in outer housing 12 between gas generant 26 and gas exit apertures 16c formed along second end closure 16 so that products resulting from combustion of the gas generant are forced to pass through the filter prior to exiting the gas generating system. In the embodiment shown in FIG. 1, filter 42 is positioned proximate outer housing second end 12b to filter the generated gases just prior to the gases exiting the outer housing through openings 12c. The filter may be formed from one of a variety of materials (for example, a carbon fiber mesh or sheet) known in the art for filtering gas generant combustion products.

When it is desired to activate the gas generating system, an electrical activation signal is sent to igniter 20, thereby igniting booster material 28. Ignition of booster material 28 results in a relatively rapid creation of combustion gases in cavity 14c of first end closure 14. As combustion of booster material 28 progresses, aperture(s) 90a in orifice plate 90 facilitate expulsion of combustion gases into the inner housing 22 producing ignition of gas generant material 26. Pressure also increases within the inner housing to a point where shim 30 ruptures, Gases flow from inner housing 22 generally radially outwardly, entering flow passage 50 and flowing generally longitudinally along the flow passage in direction “A”. The gases then pass through filter 42 to opening(s) 16c in second end closure 16, exiting the gas generating system.

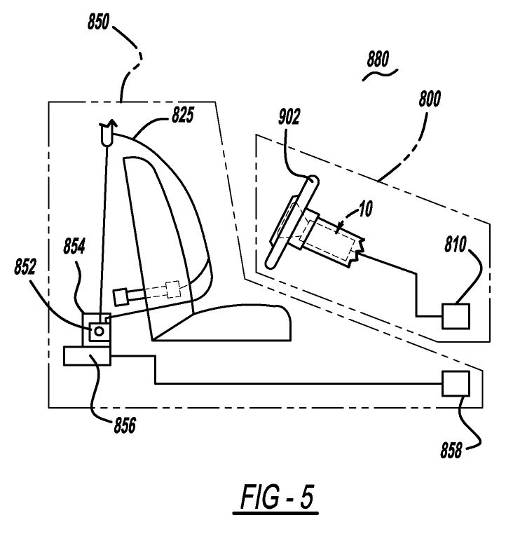

Referring to FIG. 5, in one possible application of the base assembly described herein, a gas generating including an embodiment of the base assembly is incorporated into an airbag system 800. Airbag system 800 includes at least one airbag 902 and a gas generating system including an inner housing having a shim secured thereto in accordanace with an embodiment of the present invention coupled to the airbag so as to enable fluid communication with an interior of the airbag upon activation of the gas generating system. System 800 may be in communication with a crash event sensor 810 that includes (or is in operative communication with) a crash sensor algorithm (not shown) which signals activation of airbag system 800 via, for example, activation of initator 20 (not shown in FIG. 5) in the event of a collision.

Referring again to FIG. 5, a gas generating system including an inner housing having a shim secured thereto in accordance with an embodiment of the present invention or an airbag system including such a gas generating system may be also incorporated into a broader, more comprehensive vehicle occupant protection system 880 including additional elements such as a safety belt assembly 850. Safety belt assembly 850 includes a safety belt housing 852 and a safety belt 825 extending from housing 852. A safety belt retractor mechanism 854 (for example, a spring-loaded mechanism) may be coupled to an end portion of the belt. In addition, a safety belt pretensioner 856 may be coupled to belt retractor mechanism 854 to actuate the retractor mechanism in the event of a collision. Typical seat belt retractor mechanisms which may be used in conjunction with safety belt 825 are described in U.S. Pat. Nos. 5,743,480, 5,553,803, 5,667,161, 5,451,008, 4,558,832 and 4,597,546, incorporated herein by reference. Illustrative examples of typical pretensioners with which safety belt 825 may be combined are described in U.S. Pat. Nos. 6,505,790 and 6,419,177, incorporated herein by reference.

Safety belt assembly 850 may be in communication with a crash event sensor 858 (for example, an inertia sensor or an accelerometer) that includes (or is in operative communication with) a crash sensor algorithm (not shown) which signals actuation of belt pretensioner 856 via, for example, activation of initiator 20 (not shown in FIG. 5) or another initiator (not shown) incorporated into the pretensioner. U.S. Pat. Nos. 6,505,790 and 6,419,177, previously incorporated herein by reference, provide illustrative examples of pretensioners actuated in such a manner.

It will be appreciated that the various constituents described above are formed in known manners. For example, the various components may be molded. stamped or otherwise formed from carbon steel, aluminum, metallic alloys, or any of a variety of polymers.

It will be understood that the foregoing descriptions of embodiments of the present invention are for illustrative purposes only. As such, the various structural and operational features herein disclosed are susceptible to a number of modifications commensurate with the abilities of one of ordinary skill in the art, none of which departs from the scope of the present invention as defined in the appended claims.

What is claimed is:

1. A housing assembly for a gas generating system, comprising:
a housing; and
a shim welded to the housing to provide a substantially gas-tight seal between the shim and the housing.

2. A gas generating system comprising a housing assembly in accordance with claim 1.

3. A vehicle occupant protection system comprising a housing assembly in accordance with claim 1.

4. A method for attaching a shim to a housing for a gas generating system, the method comprising the steps of:
securing the shim to the housing; and
welding the shim to the housing so as to form a substantially gas-tight seal between the shim and the housing.

5. The method of claim 4 wherein the step of securing the shim to the housing comprises the steps of:
positioning the shim along an exterior of the housing; and
providing a pressure differential between an interior of the housing and the exterior of the housing sufficient to maintain the shim in position on the housing exterior during the welding process.

6. The method of claim 4 wherein the step of securing the shim to the housing comprises the steps of:
applying an adhesive to a surface of the shim; and
applying the surface of the shim to an exterior of the housing.

7. The method of claim 4 wherein the step of securing the shim to the housing comprises the steps of:
providing a clip configured to apply a pressure to the shim when the shim is positioned along an exterior of the housing, to maintain the shim in position;
positioning the shim along the housing exterior; and
applying the clip to the shim.

8. The method of claim 4 wherein the step of securing the shim to the housing comprises the step of wrapping the shim around the housing such that opposite edges of the shim reside adjacent each other so as to enable a butt weld joint to be formed along the opposite edges.

9. The method of claim 8 wherein the step of welding the shim to the housing comprises the step of welding the opposite edges of the shim so as to form a butt weld joint along the edges.

10. A housing assembly including a housing and a shim attached to the housing by a method in accordance with claim 4.

11. A gas generating system including a housing assembly in accordance with claim 10.

12. A vehicle occupant protection system comprising a housing assembly in accordance with claim 10.
